(19) United States
(12) Patent Application Publication
(10) Pub. No.: US 2007/0001872 A1
(43) Pub. Date: Jan. 4, 2007

(54) Emergency response warning system

(76) Inventor: Aaron K. Ellison, Detroit, MI (US)

Correspondence Address: AARON K. ELLISON, 19312 BENTLER, DETROIT, MI, 48219, US

(21) Appl. No.: 11/173,353

(22) Filed: Jul. 1, 2005

(51) Int. Cl. G08G 1/095

(52) U.S. Cl. 340/907

(57) ABSTRACT

An emergency response warning system comprising a safety device implemented into a novel traffic signal device (10) and roadway/street light (12) structures. The emergency signal lights, (30) and (31) on the traffic signal (10) and (33) on the roadway light (12) will flash pronouncedly when a signal is received from an approaching emergency vehicle. Once the signal is received, all the emergency warning lights began to flash, this will alert drivers to move to the right and stop on roadways, and bring traffic to a stop at the intersection. Both structures are solar power during the day and battery operated a night for the best efficiency possible.

### BACKGROUND OF THE INVENTION

1. Field of Invention

This invention relates to traffic signals and road way lights that includes an emergency safety system.

2. Objects and Advantages

This invention relates to traffic signals and road way lights, that includes a safety device, designed to enhance the communication to motorist that an emergency vehicle is approaching in a way that is clearly understood, allowing motorist to steer clear and stop, wherein the emergency vehicle to safely pass through.

Traffic signals have been around since the early 1900s and not a whole lot has change since then.

Today, there are the standard red, yellow, and green signals that all licenses drivers understands, for directing traffic flow through an intersection. The traditional shape of these signals are of a round shape, and usually in vertical format, sometimes in a horizontal form, and they all have the same common frame. These can sometimes become difficult to see in direct sunlight which color of light is illuminated during peak hours of the day, and depending on how and what direction the signal is facing.

All emergency vehicles, such as the police, fire engines, and ambulances have sirens, multiple flashing lights to alert other motorist that they must rapidly move down the road way and proceed through the intersection regardless of the present signal condition. These methods are effective at times, when motorist are alert, but not effective enough to cut down on the amount of collisions between emergency vehicles and motorist. The reasons do vary from inattentive drivers, loud noises, and newer vehicles that are well insulated from outside noises.

There have been an assortment of devices and systems offered to remedy the problem. However, offerings of prior art have there own shortcomings as well, such as U.S. Pat. No. 6,850,169, by Payam Manavi and Keyvan, T. Diba filed May 16, 2003, has message boards, chevrons and arrows that can be confusing and not distinctive enough until you have already approached the signal to understand what it says. Problems with other prior art comprising arrows to show from which direction, an emergency vehicle is approaching, this is ineffective in the event of a police chase, do to the fact that police vehicles can approach that intersection, from all directions, at same time.

Deficiencies in prior art, U.S. Pat. No. 6,072,407 and U.S. Pat. No. 5,014,052 comprises different devices and systems for the safe passage of emergency vehicles through an intersection, none have comprise a system including roadway lights.

All above prior art require electricity and are subject to fail in a serious storm. Many prior art hang in the air from cables suspended above the intersection that can sway and swing violently causing some to fall in a storm, causing damage.

Thus the need for improvement, for self sufficient, self supporting, low maintenance traffic signal and road way lights structures, which will overcome all prior art deficiencies.

### SUMMARY OF THE PRESENT INVENTION

The present invention comprises a novel emergency response warning system implemented into a traffic signal device and a roadway light device, as powerful, pronounced flashing lights to provide visual warning to alert motorist on road ways that an emergency vehicle is approaching from behind or towards them, and for them to move to the right and stop, then at intersection using flashings warning lights along with blinking red traffic signal to bring all traffic to a stop. Thus allowing the emergency vehicles to move safely down the road way and through the intersection.

In one aspect of the main embodiment, of the present invention, is the emergency warning lights constructed to be seen from blocks away regardless of the bright sun, rain, and darkness, such that the warning lights are highly visible urging drivers to pay attention to developing circumstances. Thereby avoiding emergency vehicles that must move quickly through.

The second aspect of the present invention comprises the structures of the road way light and traffic signals where as they stand and function independently needing no cable for support.

The third aspect of the present invention such that there in no necessity for electricity Page 3. needed power, there in an improvement for conserving energy, and will not falter during electricity failure.

The forth aspect of the present invention comprises larger signal lamps for improved visibility during peak sunlight hours, thus an improvement.

### BRIEF DESCRIPTION OF THE DRAWINGS

FIG. 1 shows an elevated traffic signal device comprising;

a.) an single signal lamp lens 1, having fiber optic or LED light source displaying one illuminated color at a time.

b.) a base tower support 10.

c.) a support arm 11.

d.) a top support portion 12, which extend over the road way at an intersection.

e.) a solar cap 20 that sits on top of the base tower support 10.

f ) the inside solar strip 21, that rest on top of the support arm 11.

g.) the outside solar strip 22, which sit on top of the top support portion 12.

h.) the base tower emergency response warning lamp 30.

I.) the inside emergency response warning lamp 31.

j.) the outside emergency response warning lamps 31.

k.) the antenna receiver 40.

l.) access control panel 50.

m.) the recharging power core 55.

n.) removable, stackable, and rechargeable battery cells 56.

o.) the computer processor 57, controls all the functions of the signal, including signal timer.

p.) street sign 27, high and visible.

q.) securing nuts 13, holding fastener for base support 10.

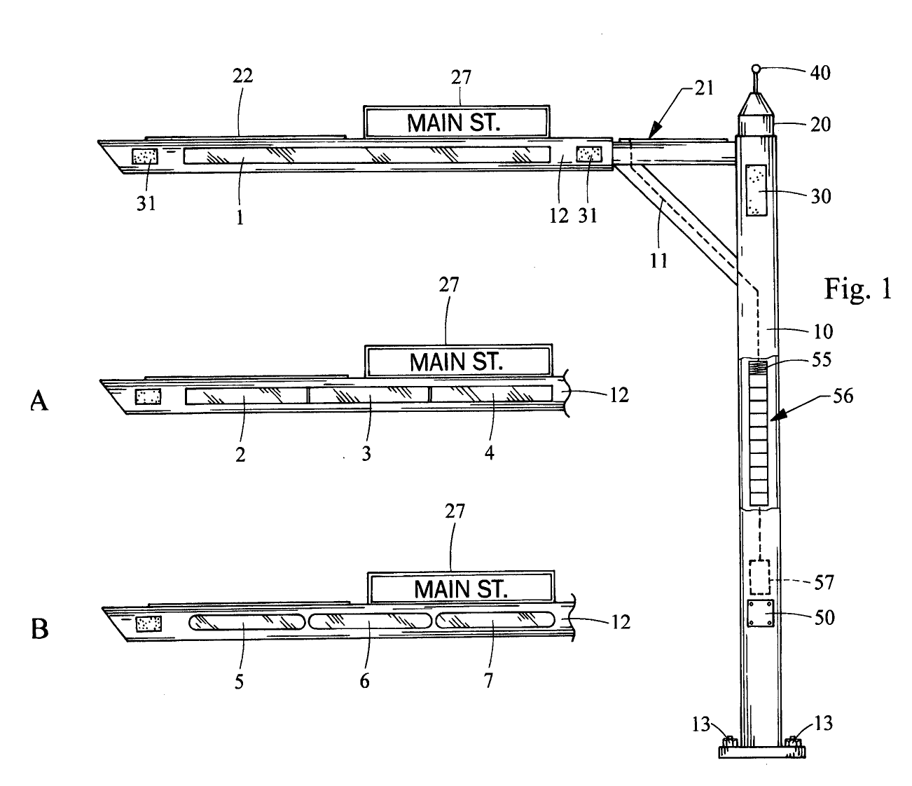

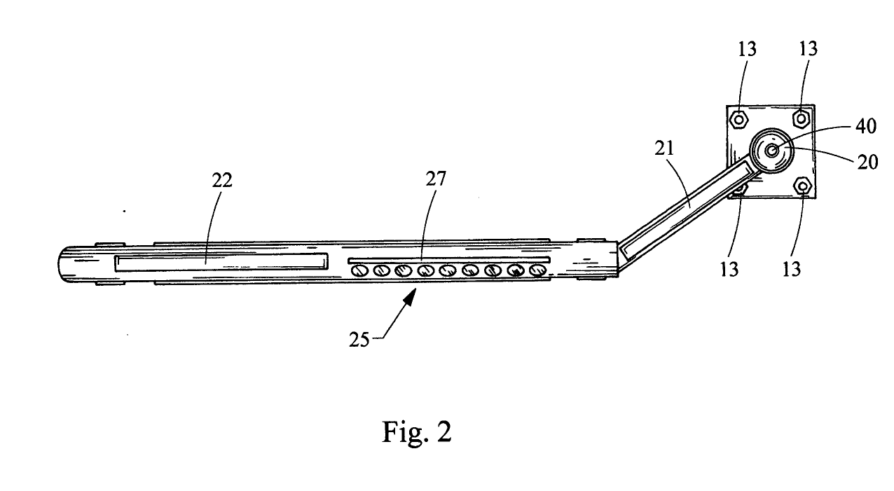

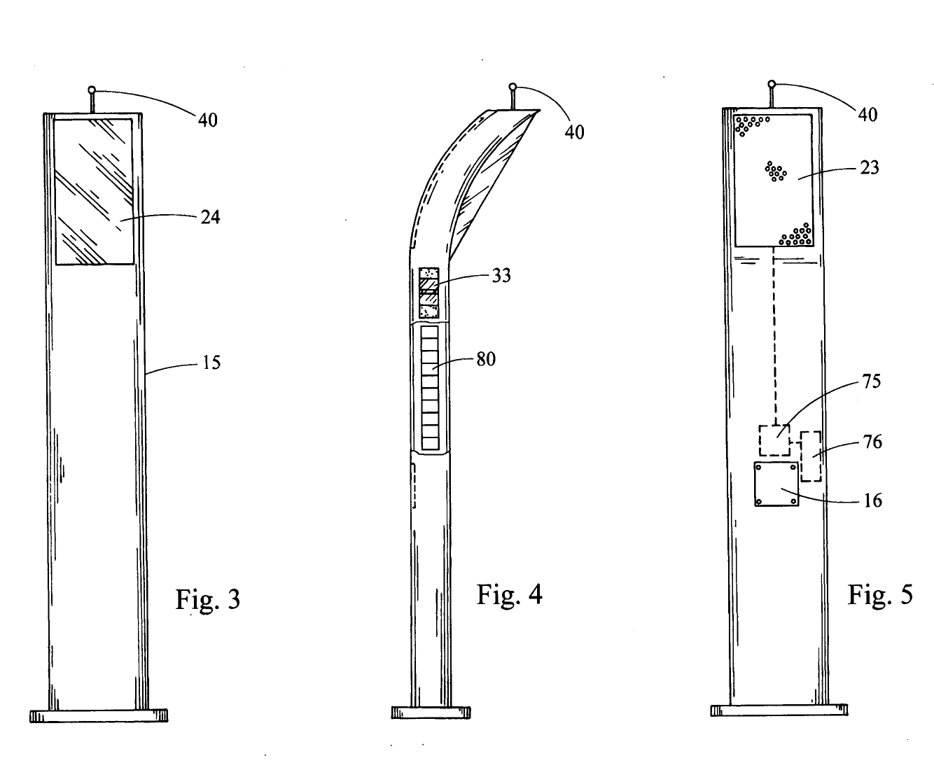

FIG. 1A shows an alternative tri panel signal lamp, comprising three rectangle panels, 2 red, 3 yellow, and 4 green, shown in horizontal configuration.

FIG. 1B show an alternative tri panel signal lamp, comprising three oblong panels, 5 red, and 6, yellow, and 7 green shown horizontally configuration

FIG. 2 shows a top view of the top support portion 12 comprising;

13 securing nuts.

20 solar cap.

21 inside solar strip.

22 outside solar strip

25 lights for illuminating the street sign 27 and night.

27 street sign.

FIG. 3 shows the front elevated view of the road way light 15 comprising;

an large light lens 24, for increased brightness, and improved night visibility.

FIG. 4 shows the side elevated view of the road way light 15 comprising;

a.) a four-panel emergency response warning lights 33 shown vertically.

b.) a cut away view of the stacked batteries 80.

c.) an antenna 40 for receiving the emergency signal from emergency vehicles

FIG. 5 shows the rear elevated view of the road way light 15 comprising;

a.) a large solar panel 23.

b.) an access control panel 16.

c.) battery charger 76.

d.) a computer processor 75.

e.) an antenna 40.

### DETAILED DESCRIPTION OF THE DRAWINGS

FIG. 1 shows an overall view of the traffic signal device, the first embodiment of this invention, comprising an unique structure of non-traditional shape, thereby featuring a round, tubular hollow base tower, 10 that stand upright and are mounted to the ground securing with nuts 13.

As shown in FIG. 1, an top support portion 12, that extends horizontally over any road way or street, further including a signal light 1 device that is larger than any traditional round lamp, having a long rectangular shape, illuminating the entire light bar either red, yellow, or green in highly visible fiber optic or LED lighting source. An alternative signals as shown in FIG. 1A having a three rectangular shaped signal lens, 2 red, 3 yellow, and 4 green. As one is illuminated, the other two has a dark tinted appearance. An additional alternative as shown in FIG. 1B having three oblong shape signals lenses, 5 being red, 6, yellow, and 7, green. As in illustration FIG. 1A, as one is illuminated, the other two has a dark tinted appearance. All signal lamps 2,3,4,5,6, and 7 can comprise either fiber optic or LED light source.

As shown in FIG. 1, the top support portion comprises emergency response warning lamps 31, along with the emergency warning lamp at the top of the base tower 30, will flash very pronouncedly once a signal is received from an emergency vehicle equipped with a special transmitter, not shown, to the antenna 40, that sits on top of the base tower 10. At an intersection, these are the lights implemented to alert the drivers to stop, whereas an emergency vehicle needs to get through quickly, without any other motorist getting in the way. No need for chevrons or arrows or message display boards as in prior art, this emergency response warning system makes no misconception about its purpose. As an emergency vehicle approaches and the warning lights flash, the signal light in each direction will automatically blink red. This is a profound way to get motorist pay attention to the developing situation.

As shown in FIG. 1, a support arm 11, which acts as a support beam to help prevent the top support portion 12 from leaning over, is connected to the base tower 10, which adds to the stability of the entire signal structure. As shown in FIG. 1, the support arm 11, plays a main role for connecting many of the structure's internal wiring. As shown in FIG. 1, a solar cap 20, in conjunction with the solar strips 21 and 22, is responsible for providing power during daylight hours, and is responsible for providing the necessary power to run the power core 55, that recharges the removable and stackable batteries cells 56.

As shown in FIG. 1, a computer processor 57, controls all the vital components of the first embodiment, as such, a timer, (not shown) for controlling the signal so that it can be programmed to fulfill the obligation of that intersection, recognizing and processing the emergency signal needed to activate the emergency warning lamps 30 and 31, and the recharging cycle for the batteries cells 56.

FIG. 2 shows and top view of the first embodiment, traffic signal devices. This illustration clearly show the advantages of the embodiment with all of the solar devices 20, 21, and 22 at the top of the top support portion 12, to maximize the light source of the sun. There is a plurality of lights 25, as shown in FIG. 2, for illuminating the street sign 27, at night. Four nuts 13, secure the bottom of the base tower 10, for strong foundation, as shown in FIG. 2.

FIG. 3 shows a roadway light device 15, the second embodiment, having a large lighting lens 24, for increased brightness at night for better visibility. Having four sides, being of a flat boxed structure, that internal components can be housed inside, as such, an removable stacked battery cells 80, as shown in FIG. 4, that is recharged by the battery charger 76, as shown in FIG. 5, during daylight hours. A computer processor 75, shown in FIG. 5, can be programmed to set a timer, not shown, to monitor the recharging cycle and for recognizing an emergency signal, as shown in FIG. 4 to activate the emergency warning lights 33, alerting drivers to move to the right and stop clear of an approaching emergency vehicle.

As shown in FIG. 4, a large solar panel 23, is positioned at the top in the rear of the light structure, providing maximum exposure the sun, absorbing energy that powers the battery charger 76, shown in FIG. 5 during the daylight hours and providing the power needed to activate the emergency warning lights 33, as shown in FIG. 4. A access panel 16, shown in FIG. 5 makes for real easy access and maintenance.

The present invention has been described in respect to a specific preferred embodiment, thereof providing an improvement versus all prior art and present embodiments. Therein, it is intended that the present invention surpass all such prior art and present embodiments as fall within the scope of the appended claims.

I claim in this invention:

1. An emergency response warning system of a traffic signal type, having a tubular base tower and top support structure wherein embedding emergency warning lights for use by any authorized emergency vehicle, said device comprising:
A said warning light system on the top of the said base tower, for high visibility and facing one or two directions being as an indicator to motorist of an approaching emergency vehicle.
A said top support comprising said solar panels for providing power during daylight hours, for the said traffic signal and the said emergency warning lights.
A said traffic signal type, embedded in the said top support having one or up to three horizontally illuminated lights comprising fiber optic or LED light source for controlling traffic flow.
An antenna on top of said base tower structure for detecting a signal from approaching emergency vehicles.
A internal battery cells that is stackable and removable, housed inside said base tower, for providing the necessary power during night hours.
A power core for recharging the said battery cells located in said base tower.
An access control panel for easy access to the plurality of internal components of said traffic signal device, located near the bottom in the rear of the said base tower.
A plurality of lights at the top of the said top support wherein providing illuminating at night for the street sign.
A computer processor for programming the plurality of the said elements above.

2. An emergency response warning system as defined in claim 1 wherein comprising a said traffic signal device, whereas comprising a plurality of emergency warning lights on top of said base tower and top support, set high for visibility to warn motorist that an emergency vehicle in approaching.

3. An emergency response warning system as defined in claim 1 wherein comprising said one traffic signal light of a long rectangle shape, for controlling the said traffic flow, comprising a said fiber optic or LED light source.

4. An emergency response warning system as defined in claim 1 wherein comprising a said traffic signal lights having a plurality of said rectangle shaped traffic signal lights, horizontally implemented for controlling the flow of traffic, comprising a said fiber optic or LED light source.

5. An emergency response warning system as defined in claim 1 wherein comprising an plurality of alternate said traffic signal lights of said oblong shape, horizontally implemented, have said fiber optic or LED light source for controlling the flow of traffic.

6. An emergency response warning system as defined in claim 1 wherein comprising solar panels on top of said base tower and top of said top support wherein responsible for providing power to operate the said traffic signal device during the daytime.

7. An emergency response warning system as defined in claim 1 wherein at the top of the said base tower having a said antenna for receiving a signal from said any emergency vehicle to actuate the said emergency warning lights on the said traffic signal device.

8. The method as defined in claim 7 whereas a said emergency vehicle approaches, the said antenna on the top of said base tower receives the signal preempting the said emergency warning lights to flash, the said traffic signal light will automatically blink red in all directions regardless of the present signal cycle stopping traffic in all directions.

9. An emergency response warning system as defined in claim 1 wherein comprising an said internal battery cells, that can be individually removed and recharged and is responsible for providing power to so that all said elements function properly for said traffic signal device during the night.

10. An emergency response warning system as defined in claim 1 wherein comprising an said power core inside of said base tower having the method of recharging the said battery cells during the daylight hours wherein the said battery cells will be able to provide the necessary power at night.

11. An emergency response warning system as define in claim 1 wherein the said base tower comprises an access control panel for easy service and maintenance as such for removing or replacing internal components wherein the said computer processor is visible from this panel.

12. An emergency response warning system as define in claim 1 wherein the said top support comprising a plurality of said lights for illuminating the front of said street sign at night, which is located at the top of said top support.

13. An emergency response warning system as define in claim 1 wherein the said base support comprises an said computer processor that can be programmed to function the said traffic signal lights, the said emergency warning lights, the said power core, processing the energy from the said solar panels, as such the said solar cap on the said top of the said base tower, the said antenna for detecting and processing the emergency signal from an approaching emergency vehicle.

14. An emergency response warning system of a roadway light device comprising:
A large upright rectangle boxed structure having four sides with a top curved slightly forward towards the front, tilting the large lighting surface towards the roadway.
A large said light for increased brightness and improved visibility, and enhanced night clarity on the said roadway.
A large solar panel for maximum exposure to the sun for absorbing energy.
An emergency response warning lamps on the two sides near the top, of the said road way light for visual aid and better awareness to motorist driving as they drive down the street.
An internal battery cells that can be removed, replaced or recharged and provides the necessary power to activate the said emergency response warning lamps, and the road way light at night.
A battery charger, powered by the said solar panel recharges the said battery cells during the daytime.
An antenna for detecting the said emergency signal from an approaching emergency vehicle.
A computer processor wherein can be programmed to function all the said elements.
A access control panel for easy access to the said computer processor as such and other internal components.

15. An emergency response warning system as defined in claim 14 wherein comprising a said roadway light structure having a said rectangle boxed structure for maximum strength and rigidity.

16. An emergency response warning system as defined in claim 14 wherein comprising a said large roadway light device for comprising an internal sensor, not shown, will illuminating the street at night therefore an improved brightness and enhanced visibility and clarity.

17. An emergency response warning system as defined in claim 14 wherein comprising a said solar panel device affix to the top of the said roadway light structure having a rear-facing surface.

18. The method as defined in claim 17 whereas the said solar panel affixes at the top of said roadway light structure in the rear whereas the said solar panel absorbs energy from the sun providing the necessary power to the said battery charger to recharge the said battery cells as defined in claim 14 during the day time hours.

19. The method as defined in claim 18 whereas the said solar panel being affixed to the top rear of the said road way light structure whereas absorbing energy from the sun providing power to run the said emergency response warning lamps as defined in claim 14, being implemented into each side of the said roadway light structure to be initiated by receiving a signal from an emergency vehicle.

20. An emergency response warning system as defined in claim 14 having said internal battery cells for operating the said roadway light during nighttime hours.

21. The method as defined in claim 20 whereas the said battery cells are stacked within the said road way light structure and can be removed for replacing and recharged during the daytime hours.

22. An emergency response waning system as defined in claim 14 wherein comprising emergency said warning lamps to alert other motorist driving down a roadway that an emergency vehicle is approaching and must pass through.

23. The method as defined in claim 22 therefore when the said emergency response warning lamps began to flash pronouncedly alerting drivers to move the right of the road way and stop allowing the emergency vehicle to safely pass through.

24. An emergency response warning system as defined in claim 14 wherein having a antenna on top of the said roadway light structure to better receive the emergency signal from and approaching emergency vehicle that is equipped with a special transmitter device not shown.

25. An emergency response warning system as defined in claim 14 comprising a computer processor wherein can be programmed to control the functions of the said emergency warning lamps and detecting and processing the said emergency signal from the said antenna, and a timer not shown as to when an internal sensor, not shown, will automatically switch the said roadway light on.

26. An emergency response warning system as defined in claim 14 wherein comprising an access control panel whereas having easy access to the vital internal components.

27. The method as define in claim 26 wherein the said access control panel allows one to maintenance and program all systems within the said computer processor that is in view inside the said roadway light structure when the said access control panel lid is removed.
